(19) United States
(12) Patent Application Publication
(10) Pub. No.: US 2016/0252139 A1
(43) Pub. Date: Sep. 1, 2016

(54) CARDAN SHAFT WITH SAFETY DEVICE FOR AGRICULTURAL OR INDUSTRIAL USE

(71) Applicant: Emanuele COLOMBINI, Livraga (IT)

(72) Inventor: Emanuele COLOMBINI, Livraga (IT)

(21) Appl. No.: 15/028,888

(22) PCT Filed: Sep. 29, 2014
(86) PCT No.: PCT/EP2014/070736

§ 371 Date: Apr. 12, 2016

(30) Foreign Application Priority Data
Oct. 14, 2013 (IT) MI2013A001688

(51) Int. Cl. F16D 3/84; F16P 3/08; A01B 71/06

(52) U.S. Cl. CPC F16D 3/843; A01B 71/06; F16P 3/08

(57) ABSTRACT

A Cardan shaft with safety device for agricultural or industrial use, comprising a shaft which is connected, at each of its axial ends, to a corresponding universal joint, the safety device comprising a safety cover that comprises a tubular body that is arranged around the shaft and is provided, at its axial ends, with two bell-shaped elements that are adapted to extend beyond the corresponding axial end of the shaft, the safety cover being uncoupled from the rotation of the shaft about its own axis, each one of the bell-shaped elements being slideable, with respect to the shaft, along the axis of the shaft, from an active position, in which it is extended beyond the corresponding axial end of the shaft so as to cover at least partially the corresponding universal joint, to an assembly position.

The present invention relates to a Cardan shaft with safety device for agricultural or industrial use.

As is known, Cardan shafts are composed of a shaft, generally having a telescopic structure, at the axial ends of which two universal joints are coupled which can be connected respectively to the two mechanical elements that must be connected to each other in order to ensure the transmission of a rotary motion from one mechanical element to the other.

The use of two universal joints ensures the transmission of the rotary motion between two mechanical elements, usually two shafts, which are variously oriented, and the presence of a telescopic shaft, constituted usually by a hollow shaft with a splined inner profile or in any case with a noncircular transverse cross-section and by a shaft with an outer profile that is contoured correspondingly so as to mate slidingly within the hollow shaft, allows to adapt the length of the Cardan shaft to the distance between the two mechanical elements to be mutually connected.

A typical use of Cardan shafts in agriculture is the coupling between the power take-off of the tractor and a work vehicle or a tool to be operated.

To prevent the Cardan shaft, during its rotation, from being able to interfere with objects or people in the vicinity, a safety cover is usually provided.

The safety covers for Cardan shafts that are currently in use are composed usually of a telescopic tube that is extended around the telescopic shaft and by two caps or bell-shaped elements that are arranged at the ends of the telescopic tube and cover almost entirely the two universal joints arranged at the ends of the telescopic shaft. Such caps are fixed proximate to the axial ends of the telescopic shaft so that they are coupled to the corresponding part of the telescopic shaft as regards axial motion, but so as to allow the telescopic shaft to rotate freely about its own axis with respect to the caps. In this manner, the cover can extend and contract, following the elongations and contractions of the telescopic shaft, allowing it to rotate freely about its own axis without entraining in rotation also the cover which, for the sake of greater safety is in any case blocked by way of chains or other means.

Such safety covers, due to the fact that the caps cover almost entirely the universal joints, suffer the drawback that they cause the operation for coupling the universal joints to the shafts that must be mutually connected by means of the Cardan shaft to become complicated and laborious.

However, the safety cover is an indispensable element to avoid accidents that can have even severe consequences, as can be noted from statistics on the subject of accidents, which show that the lack of use or incorrect use of safety covers of Cardan shafts is the main cause of accidents in the agricultural sector.

The aim of the present invention is to solve the problem described above, by providing a Cardan shaft with a safety device for agricultural or industrial use that makes it particularly simple and easy to couple the universal joints to the mechanical elements to be mutually connected by means of the Cardan shaft and offers adequate assurances against the danger of accidents.

Within this aim, an object of the invention is to provide a Cardan shaft with a safety device which, during the operation of the Cardan shaft, assuredly avoids its contact with people or items that might be in the vicinity.

Another object of the invention is to provide a Cardan shaft with a safety device that prevents the possibility of use of the Cardan shaft without adequate protection.

A further object of the invention is to provide a Cardan shaft with a safety device that can be manufactured in a relatively simple manner and offers the greatest assurances of reliability and safety in use.

This aim, as well as these and other objects that will become better apparent hereinafter, are achieved by a Cardan shaft with safety device for agricultural or industrial use, comprising a shaft which is connected, at each of its axial ends, to a corresponding universal joint, said safety device comprising a safety cover that comprises a tubular body of variable length that is arranged around said shaft and is provided, at its axial ends, with two bell-shaped elements that are adapted to extend beyond the corresponding axial end of said shaft, said safety cover being uncoupled from the rotation of said shaft about its own axis, characterized in that each one of said bell-shaped elements can slide, with respect to said shaft, along the axis of said shaft, from an active position, in which it is extended beyond the corresponding axial end of said shaft so as to cover at least partially the corresponding universal joint, to an assembly position, in which it is retracted in the direction of the central region of said shaft with respect to said active position, safety means being provided for locking each one of said bell-shaped elements in said active position.

Further characteristics and advantages of the invention will become better apparent from the description of a preferred but not exclusive embodiment of the Cardan shaft with safety device according to the invention, illustrated by way of nonlimiting example in the accompanying drawings, wherein:

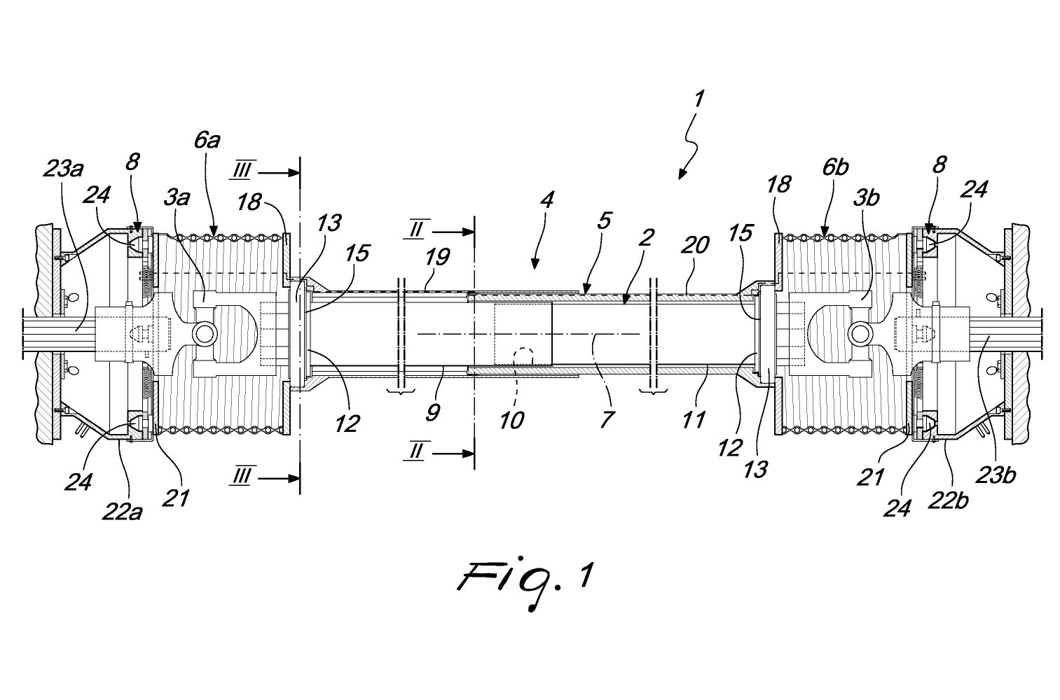

FIG. 1 is an axial sectional view of the Cardan shaft with safety device according to the invention, with the shaft shown schematically;

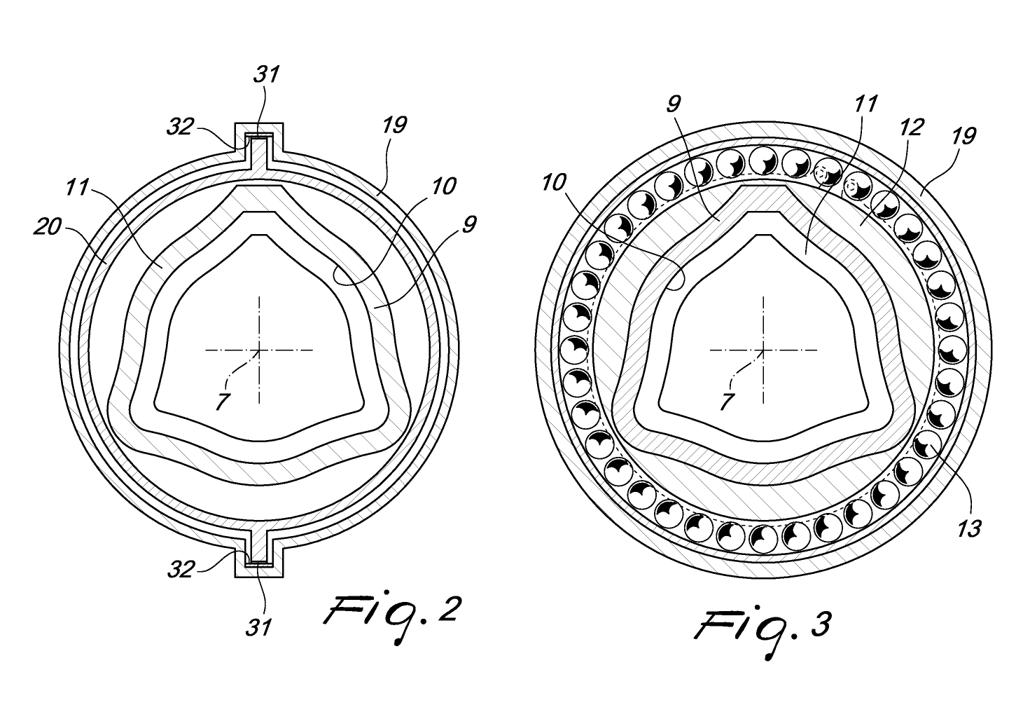

FIG. 2 is an enlarged-scale schematic sectional view of FIG. 1, taken along the line II-II;

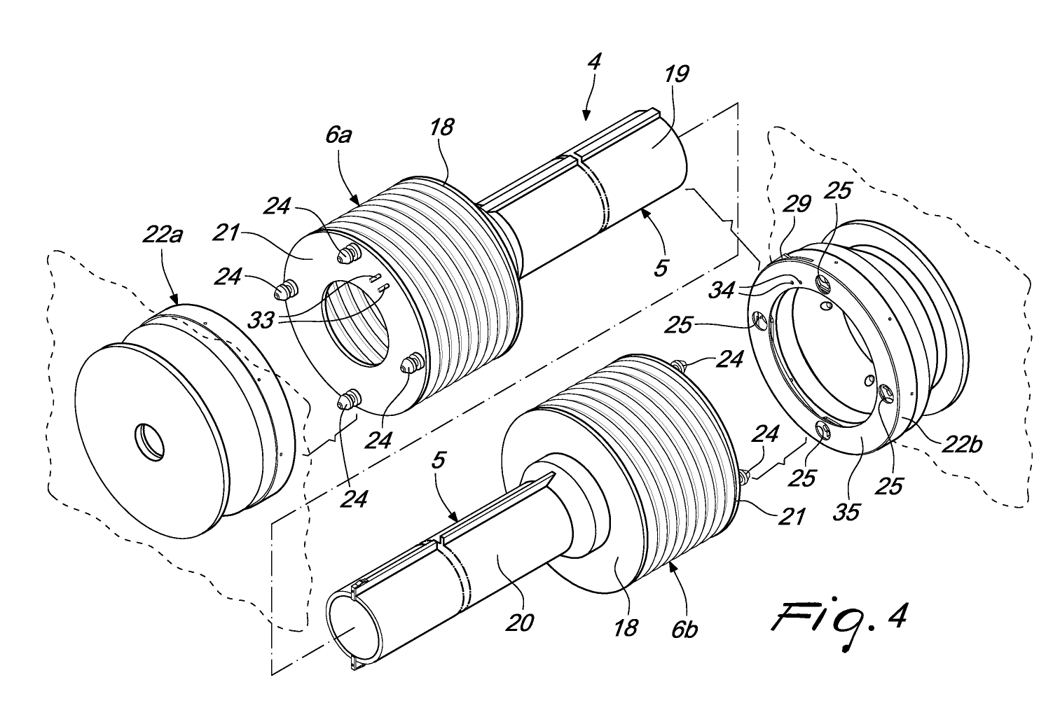

FIG. 3 is an enlarged-scale schematic sectional view of FIG. 1, taken along the line III-III;

FIG. 4 is a partially exploded perspective view of the safety device;

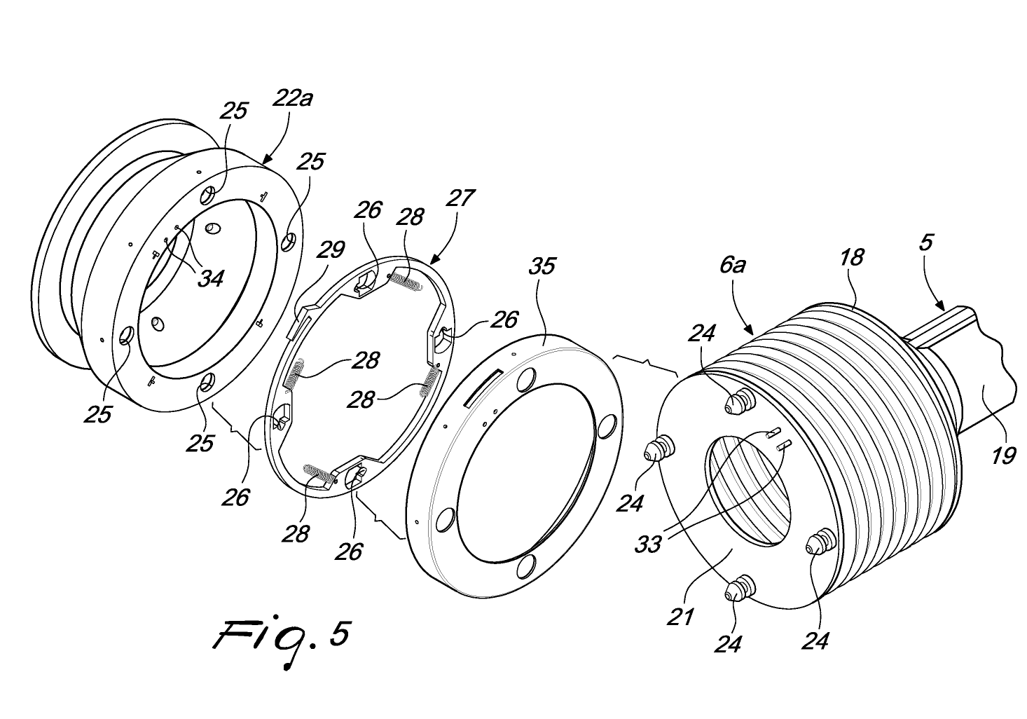

FIG. 5 is a further exploded view of a detail of the safety device;

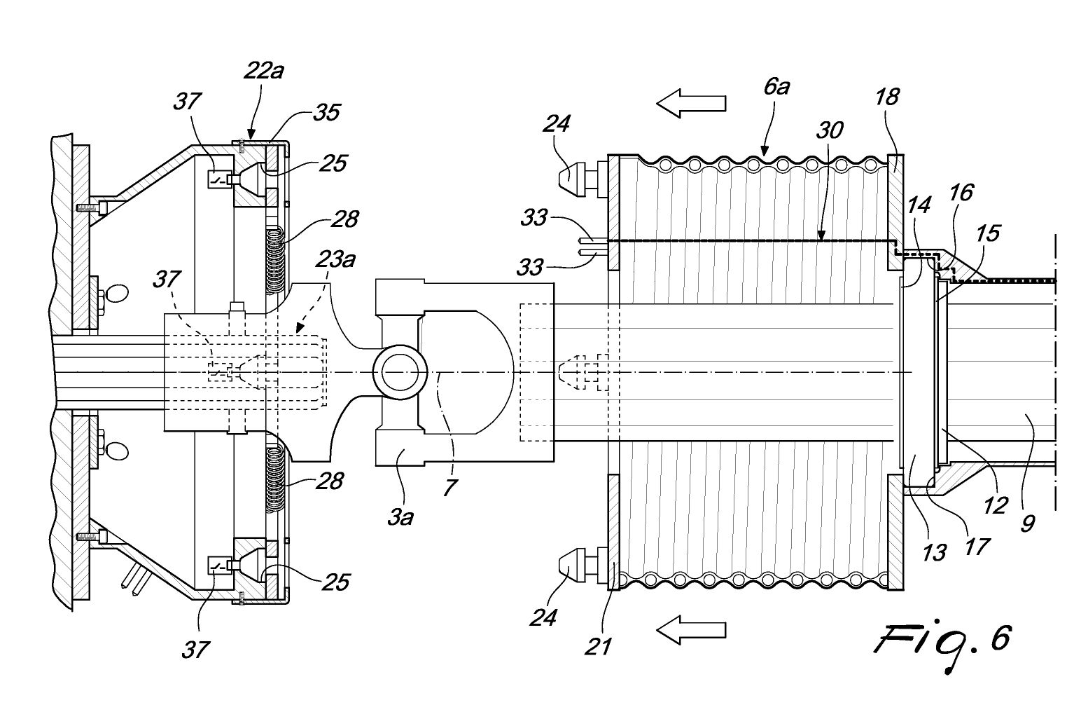

FIG. 6 is an enlarged-scale axial sectional view of an axial end of the Cardan shaft with safety device according to the invention, with a bell in the assembly position;

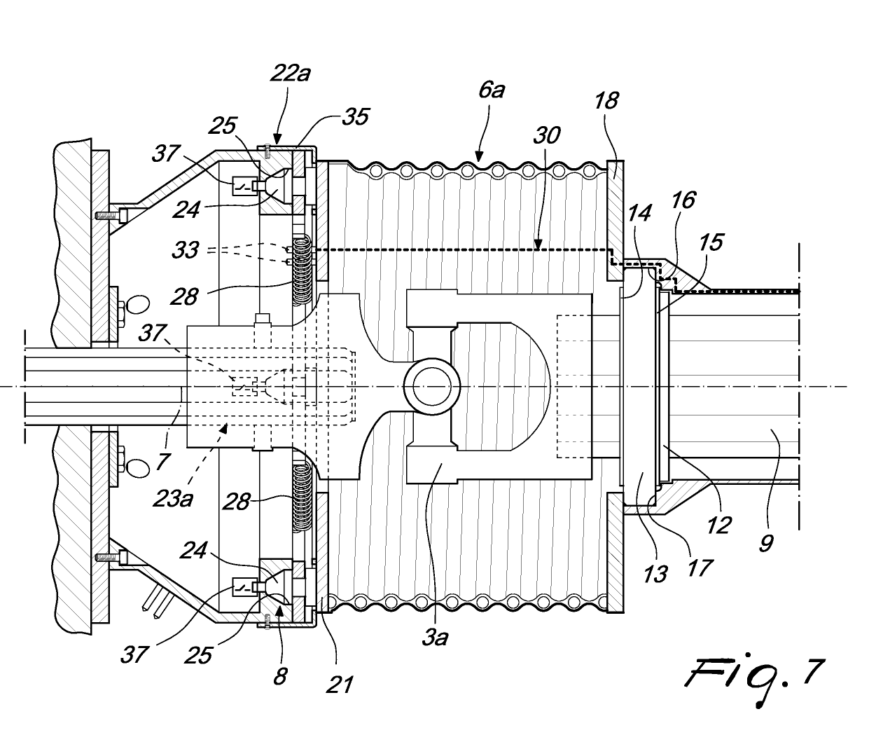

FIG. 7 is an enlarged-scale axial sectional view of an axial end of the Cardan shaft with safety device according to the invention, with a bell in the position for use;

FIG. 8 is a front view of one of the mechanical elements to be mutually connected by means of the Cardan shaft with safety device according to the invention;

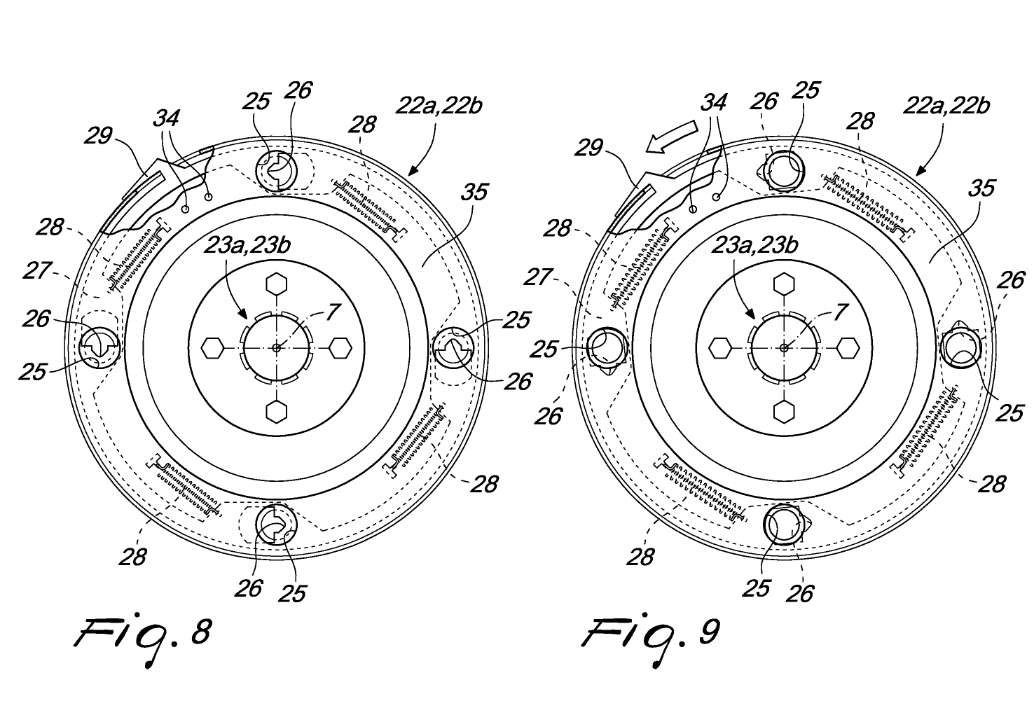

FIG. 9 is a view, similar to FIG. 8, highlighting the operation of part of the safety means;

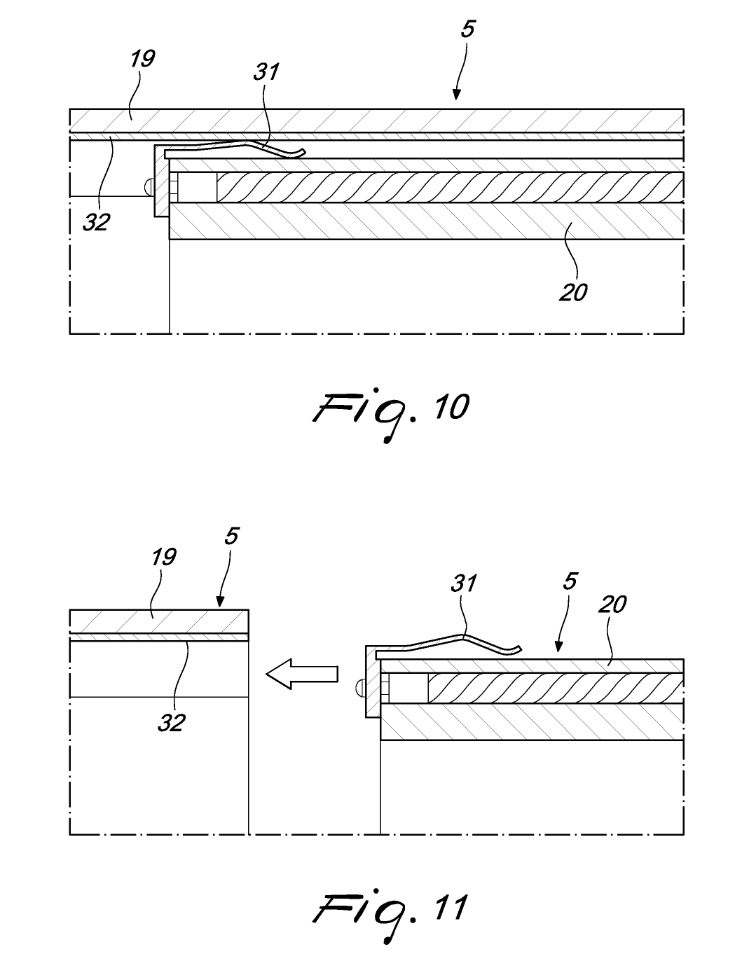

FIG. 10 is an enlarged-scale view of a detail of FIG. 1;

FIG. 11 is a view of the same detail of FIG. 10 during the assembly of the safety cover;

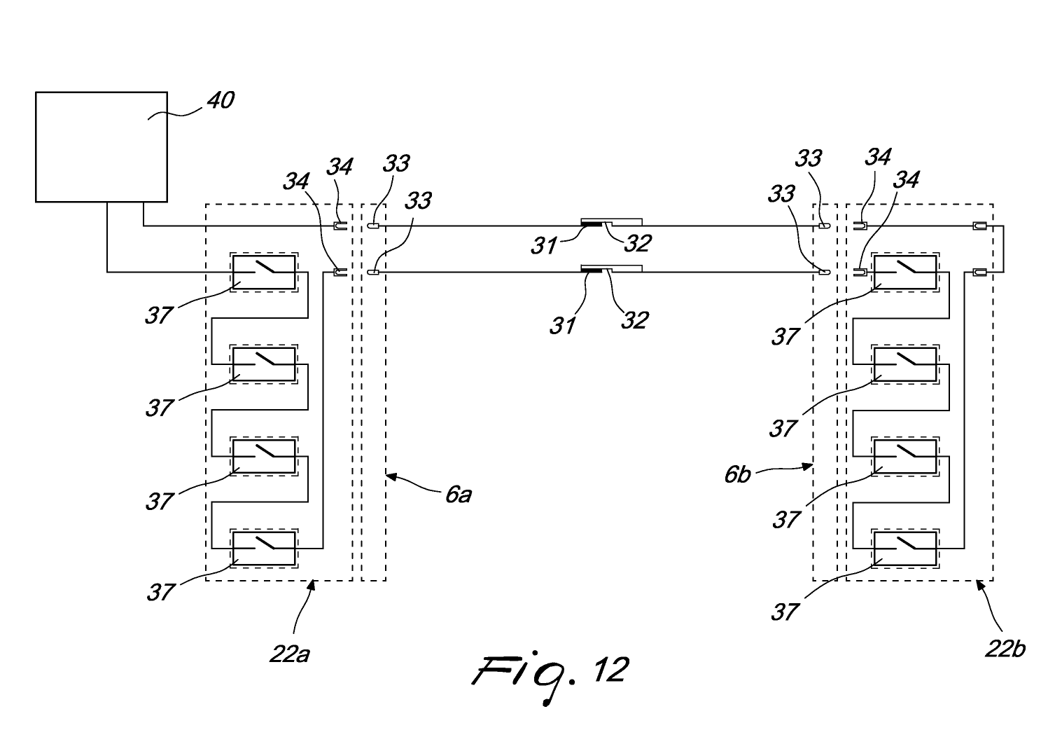

FIG. 12 is an electrical diagram related to the safety means.

With reference to the figures, the Cardan shaft with safety device according to the invention is designated generally by the reference numeral 1. The Cardan shaft comprises, in a per se known manner, a shaft 2 which is connected, at each one of its axial ends, to a corresponding universal joint 3a, 3b. The safety device comprises a safety cover 4, which covers the shaft 2 and is constituted by a tubular body 5 of variable length, which is arranged coaxially around the shaft 2 and is provided, at its axial ends, with two bell-shaped elements 6a, 6b, which are adapted to extend beyond the corresponding axial end of the shaft 2 so as to cover at least partially the universal joints 3a, 3b. The safety cover 4 is uncoupled from the rotation of the shaft 2 about its own axis 7, as will become better apparent hereinafter.

According to the invention, each one of the bell-shaped elements 6a, 6b can slide, with respect to the shaft 2, along the axis 7 of the shaft 2 from an active position, in which it is extended beyond the corresponding axial end of the shaft 2 so as to cover at least partially the corresponding universal joint 3a, 3b, to an assembly position, in which it is retracted in the direction of the central region of the shaft 2, i.e., toward the other bell-shaped element 6b, 6a with respect to the active position. The Cardan shaft with safety device according to the invention is further provided with safety means 8 to lock each one of the bell-shaped elements 6a, 6b in the active position.

More particularly, the shaft 2 preferably has a telescopic structure composed of a female component 9 provided with an axial cavity 10 that has, in transverse cross-section, a noncircular shape, and a male component 11, which is arranged coaxially with respect to the female component 9 and is coupled slidingly in the axial cavity 10 of the female component 9. In this manner, the female component 9 and the male component 11 are mutually integral in rotation about the common axis 7 and can slide axially with respect to each other in order to vary the useful length of the shaft 2.

In the illustrated embodiment, the axial cavity 10, as well as the female component 9 and the male component 11, have in transverse cross-section a triangular or three-lobed shape, but might have other shapes suitable to render the two components integral in rotation about the common axis 7, like the telescopic shafts used in Cardan shafts of the known type.

One of the bell-shaped elements 6a, 6b, constituted in the illustrated embodiment by the bell-shaped element 6a, is associated preferably with the female component 9 of the shaft 2, while the other bell-shaped element 6b is associated with the male component 11 of the shaft 2.

In greater detail, for each one of the bell-shaped elements 6a, 6b there is a supporting element 12, which is arranged around the shaft 2 and is interposed respectively between the female component 9 and between the male component 11 and the corresponding bell-shaped element 6a, 6b. The supporting elements 12 can slide axially respectively along the female component 9 and along the male component 11 of the shaft 2 and support the corresponding bell-shaped element 6a, 6b so that it can rotate about the axis 7 by means of a bearing 13. In this manner, the bell-shaped elements 6a, 6b are uncoupled from the rotation of the shaft 2 about its own axis 7 and can slide axially along said shaft 2.

Each bearing 13 is locked axially on the corresponding supporting element 12, which is annular, between an axial shoulder 14 and an elastic ring 15. Moreover, each bearing 13 is inserted in a seat 16 defined in the corresponding bell-shaped element 6a, 6b, and is locked axially with respect to the bell-shaped element 6a, 6b between an axial shoulder 17 and a flange 18 that is applied to the inlet of the seat 16.

The tubular body 5 is composed conveniently of two tubes, preferably made of synthetic material, respectively a female tube 19 and a male tube 20 that is inserted coaxially in the female tube 19, such tubes being able to slide axially with respect to each other in order to vary the useful length of the tubular body 5 and therefore of the safety cover 4. The male tube 20 is connected, with an axial end thereof that protrudes from an axial end of the female tube 19, to the bell-shaped element 6b, and the opposite end of the female tube 19 is connected to the other bell-shaped element 6a.

Each bell-shaped element 6a, 6b can be made of molded synthetic material or can be constituted simply by a portion of helically wound pipe which is fixed, at one of its axial ends, to the flange 18 and, at its other axial end, to another flange 21.

The safety device, in addition to the safety cover 4, comprises, for each bell-shaped element 6a, 6b, a housing or complementary bell-shaped element 22a, 22b, which surrounds the portion, usually a shaft, of the mechanical elements 23a, 23b to be connected to the universal joints 3a, 3b. Like in all mechanical transmissions, one of the mechanical elements 23a, 23b is the driving one while the other one is the driven one.

The safety means 8 comprise preferably an insertion coupling between each of the bell-shaped elements 6a, 6b and the corresponding housing or complementary bell-shaped element 22a, 22b.

More particularly, the flanges 21 are each provided with a plurality of pins 24, which are mushroom-shaped and protrude axially toward the outside of the corresponding bell-shaped element 6a, 6b. The pins 24 can be inserted in seats 25 defined in the housing 22a, 22b of the corresponding mechanical element 23a, 23b to be coupled to the corresponding universal joint 3a, 3b. In the seats 25 there are guillotine-type locking elements 26, which reduce the opening for accessing the seats 25 by locking the pins 24 once they have been inserted in the seats 25.

The seats 25 are distributed with their axes along a cylindrical surface and the locking elements 26 are supported by a ring 27 that is arranged in the corresponding housing 22a, 22b coaxially to the cylindrical surface. The locking elements 26 are constituted by portions of the ring 27 that are arranged proximate to the seats 25 and the ring 27 can rotate manually about its own axis 7 in order to move the portions 26 so as to free the seats 25 in order to disengage the pins 24 in contrast with the action of elastic means, constituted by springs 28, which tend to keep the ring 27 in a position in which the portions 26 reduce the passage of the seats 25, so as to retain the pins 24 inside them. The manual rotation of the ring 27 in order to disengage the portions 26 from the pins 24 is facilitated by the presence of an actuation lever 29, which is integral with the ring 27 and protrudes from the corresponding housing 22a, 22b.

For the sake of completeness in description, it should be noted that the ring 27 and the springs 28 are retained in the corresponding housing 22a, 22b by a cover 35 that is fixed to the housing 22a, 22b. In such cover there are passages for accessing the seats 25 and there is a lateral opening from which the actuation lever 29 protrudes.

Advantageously, the safety means 8 comprise sensors for detecting that each one of the bell-shaped elements 6a, 6b has coupled to the corresponding housing 22a, 22b, and such sensors are connected functionally to a control and actuation element 40, which actuates or allows to actuate the driving mechanical element 23a or 23b so that the actuation of the driving mechanical element 23a or 23b can occur only when the bell-shaped elements 6a, 6b are coupled correctly to the corresponding housings 22a, 22b.

The sensors can be constituted for example by proximity sensors that are applied to the housings 22a, 22b and are capable of detecting the correct coupling of such elements to the bell-shaped elements 6a, 6b, or can be constituted by microswitches 37, as shown schematically in FIGS. 6, 7 and 12, which are closed by the correct coupling of the bell-shaped elements 6a, 6b to the housings 22a, 22b.

More particularly, in the illustrated embodiment, the safety means 8 comprise an electric circuit 30, which is connected to the control and actuation element 40 and is extended partly in the tubular body 5 and in the bell-shaped elements 6a, 6b and partly in the housings 22a, 22b. The bell-shaped elements 6a, 6b and the housings 22a, 22b are provided with electrical contacts, constituting by plugs 33 and sockets 34, which can be mutually coupled upon the connection of each one of the bell-shaped elements 6a, 6b to the corresponding housing 22a, 22b in order to ensure the continuity of the electric circuit 30. Along the electric circuit 30 there are, in series, the microswitches 37, which are located at the seats 25 and are closed as a consequence of the correct insertion and locking of the pins 24 in the seats 25. The closure of the electric circuit 30 provides the control and actuation element 40 with clearance for the actuation of the driving mechanical element, which in this case is constituted by the mechanical element 23a.

The branch of the electric circuit 30 that is extended within the tubular body 5 comprises a sliding electric contact 31, which is fixed to the male tube 20 and engages slidingly an electrically conducting strip 32 that is applied to the inner lateral surface of the female tube 19 and is extended parallel to the axis 7. The sliding electric contact 31 and the strip 32 are connected to one or more plugs 33 that protrude from the flange 21 of the bell-shaped elements 6a, 6b and can engage the sockets 34 defined in the corresponding housing 22a, 22b.

Use of the Cardan shaft with safety device according to the invention is as follows.

When the universal joints 3a, 3b of the Cardan shaft must be connected to the shafts of the mechanical elements 23a, 23b to be connected to each other, the bell-shaped elements 6a, 6b are moved to the assembly position by making them slide along the male component 11 and along the female component 9 of the shaft 2. In this manner, the universal joints 3a, 3b are completely exposed and therefore visible, making it particularly easy to couple the universal joints 3a, 3b to the shafts of the mechanical elements 23a, 23b to be connected to each other.

Once the coupling of the universal joints 3a, 3b to the shafts of the mechanical elements 23a, 23b to be mutually connected has been performed, the operator slides the bell-shaped elements 6a, 6b along the male component 11 and along the female component 9 of the shaft 2, moving them to the active position, i.e., so that they engage the bell-shaped elements 6a, 6b with the corresponding housing 22a, 22b.

In particular, by way of this sliding of the bell-shaped elements 6a, 6b, the pins 24 are inserted in the seats 25, in which they are locked automatically by the ring 27, ensuring the full covering of the universal joints 3a, 3b and of the shafts of the mechanical elements 23a, 23b that are mutually connected by means of the universal joint 3a, 3b.

While the pins 24 are coupled to the seats 25, the plugs 33 couple to sockets 34 and the microswitches 37 are closed, thus closing the electric circuit 30 that provides the control and actuation element 40 with clearance to actuate the driving mechanical element 23a or 23b, which is constituted for example by the power take-off of a tractor.

It should be noted that if at least one of the two bell-shaped elements 6a, 6b is not fixed correctly to the corresponding housing 22a, 22b, the electric circuit 30 remains open and therefore the driving mechanical element 23a, 23b cannot be actuated.

In this manner one has the assurance that the Cardan shaft according to the invention is protected constantly and correctly during its operation.

In practice it has been found that the Cardan shaft with safety device according to the invention achieves fully the intended aim, since it facilitates considerably the operations for coupling the universal joints to the mechanical elements to be mutually connected and offers adequate assurances of safety against the danger of accidents.

The Cardan shaft with safety device thus conceived is susceptible of numerous modifications and variations, all of which are within the scope of the appended claims; all the details may further be replaced with other technically equivalent elements.

In practice, the materials used, as well as the dimensions, may be any according to requirements and to the state of the art.

The disclosures in Italian Patent Application No. MI2013A001688 from which this application claims priority are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

1-10. (canceled)

11. A Cardan shaft with safety device for agricultural or industrial use, comprising a shaft which is connected, at each of axial ends thereof, to a corresponding universal joint, said safety device comprising a safety cover that comprises a tubular body of variable length that is arranged around said shaft and is provided, at its axial ends, with two bell-shaped elements that are adapted to extend beyond the corresponding axial end of said shaft, said safety cover being uncoupled from the rotation of said shaft about its own axis, wherein each one of said bell-shaped elements can slide, with respect to said shaft, along the axis of said shaft, from an active position, in which it is extended beyond the corresponding axial end of said shaft so as to cover at least partially the corresponding universal joint, to an assembly position, in which it is retracted in the direction of the central region of said shaft with respect to said active position, safety means being provided for locking each one of said bell-shaped elements in said active position.

12. The Cardan shaft according to claim 11, wherein said shaft has a telescopic structure that is composed of a female component provided with an axial cavity that has, in a transverse cross-section, a noncircular shape, and a male component, which is coaxial to said female component and couples slidingly within said axial cavity of said female component, said female component and said male component being integral with respect to each other in rotation about the axis and being able to slide axially with respect to each other in order to vary the useful length of said shaft; one of said bell-shaped elements being associated slidingly with said female component and the other one of said bell-shaped elements being associated slidingly with said male component.

13. The Cardan shaft according to claim 12, further comprising, for each one of said bell-shaped elements, a supporting element that is arranged around said shaft and is interposed respectively between said female component or between said male component of the shaft and the corresponding bell-shaped element; said supporting element being able to slide axially along said female component or along said male component of the shaft and supporting, so that it can rotate about the axis of said shaft, the corresponding bell-shaped element by means of a bearing.

14. The Cardan shaft according to claim 11, wherein said safety device comprises, for each one of said bell-shaped elements, a housing or a complementary bell-shaped element that surrounds a portion of mechanical elements, one of which is a driving one while the other is a driven one, to be connected to said universal joints; said safety means comprising an insertion coupling between each one of said bell-shaped elements and the corresponding housing or complementary bell-shaped element.

15. The Cardan shaft according to claim 14, wherein said safety means comprise sensors for detecting that each one of said bell-shaped elements has coupled to the corresponding complementary bell-shaped element; said sensors being connected functionally to a control and actuation element that actuates the driving mechanical element for the actuation of the driving mechanical element only when said bell-shaped elements are coupled to the corresponding housings.

16. The Cardan shaft according to claim 15, wherein said safety means comprise an electric circuit, which is connected to said control and actuation element that actuates the driving mechanical element; said electric circuit extending partly within said tubular body and within said bell-shaped elements and partly within said housings; said sensors comprising microswitches that are arranged in said housings and can be actuated upon the connection of each one of said bell-shaped elements to the corresponding housing for the closure of said electric circuit.

17. The Cardan shaft according to claim 11, wherein said tubular body is arranged coaxially to said shaft and is composed of two tubes, respectively a female tube and a male tube that is inserted coaxially in said female tube, said male and female tubes being able to slide axially with respect to each other in order to vary a useful length of said tubular body, said male tube being connected, by means of one of its axial ends that protrudes from an axial end of said female tube, to one of said bell-shaped elements and an opposite axial end of said female tube being connected to another one of said bell-shaped elements.

18. The Cardan shaft according to claim 17, wherein the branch of the electric circuit that lies within said tubular body comprises at least one sliding electric contact that is fixed to either said male tube or said female tube, said at least one sliding electric contact engaging slidingly a corresponding electrically conducting strip that is fixed to the other one between said male tube and said female tube and is extended parallel to the axis of said male tube and said female tube.

19. The Cardan shaft according to claim 14, wherein said insertion coupling comprises pins that protrude from the end of said bell-shaped elements that is directed outwardly and can be inserted in seats provided in the housing of the corresponding mechanical element to be coupled to the corresponding universal joint; guillotine-type locking elements for said pins being provided in said seats.

20. The Cardan shaft according to claim 19, wherein said insertion coupling comprises a lever for actuating said locking elements for their disengagement from said pins in contrast with elastic means.
